(19) United States
(12) Patent Application Publication
(10) Pub. No.: US 2017/0060255 A1
(43) Pub. Date: Mar. 2, 2017

(54) OBJECT DETECTION APPARATUS AND OBJECT DETECTION METHOD THEREOF

(71) Applicant: SAMSUNG ELECTRONICS CO., LTD., Suwon-si (KR)

(72) Inventors: Mikiyas TESHOME, Suwon-si (KR); Nam-su HA, Anyang-si (KR)

(73) Assignee: SAMSUNG ELECTRONICS CO., LTD., Suwon-si (KR)

(21) Appl. No.: 15/213,974

(22) Filed: Jul. 19, 2016

(30) Foreign Application Priority Data
Aug. 26, 2015 (KR) 10-2015-0120068

(51) Int. Cl. G06F 3/01; G06T 7/20; G06K 9/52; G06K 9/00; G06F 3/03; G06T 7/60

(52) U.S. Cl. CPC G06F 3/017; G06F 3/0304; G06T 7/60; G06K 9/52; G06K 9/00335; G06T 7/20; G06T 2207/30196

(57) ABSTRACT

An object detection apparatus is provided. The object detection apparatus includes a storage configured to store a plurality of detectors respectively trained to detect an object from different viewpoints; an image receiver configured to receive an image captured by an image capturing apparatus from a viewpoint, wherein an object is captured within the image; and a controller configured to detect the object in the image by applying a detector corresponding to the viewpoint from which the image is captured from among the plurality of detectors.

### CROSS-REFERENCE TO RELATED APPLICATIONS

This application claims priority from Korean Patent Application No. 10-2015-0120068, filed in the Korean Intellectual Property Office on Aug. 26, 2015, the disclosure of which is incorporated herein by reference.

### BACKGROUND

1. Field

Aspects of exemplary embodiments described herein relate to an object detection apparatus and an object detection method, and more specifically, to an object detection apparatus which can rapidly detect an object in an image and an object detection method.

2. Description of the Related Art

Various electronic devices are used thanks to the development of electronic technology and these electronic devices provide a variety of functions.

A method of controlling electronic devices is becoming varied according to provision of the various functions. For example, various control methods such as control by a remote device, control by motion recognition, control by voice recognition and the like exist. Among these, the control method by recognizing a user's motion may have an advantage in that a separate remote controller may not be needed and its accuracy may be higher than accuracy of the voice recognition control.

For the motion recognition, an image capturing apparatus such as a camera may be used and it may be important to exactly and rapidly detect an object from a captured image.

However, even when capturing an identical object, according to a direction in which an image capturing apparatus takes an image or according to a capturing viewpoint, different forms are captured. Therefore, an apparatus trained to detect an object in a certain capturing direction may inevitably have a low detection rate.

Accordingly, even though methods of training an apparatus to detect an object from various image capturing viewpoints to detect an object have been introduced, there is a problem that an object detection speed gets slow due to consideration of all the various image capturing viewpoints.

### SUMMARY

An aspect of exemplary embodiments relates to an object detection apparatus which can rapidly detect an object in an image and an object detection method.

According to an exemplary embodiment, there is provided an object detecting apparatus including: a storage configured to store information from a plurality of detectors respectively trained to detect an object from different viewpoints; an image capturing apparatus configured to capture an image from a viewpoint, wherein the object is captured within the image; an image receiver configured to receive the image in which the object is captured; and a controller configured to detect the object in the image by applying information from a detector corresponding to the viewpoint from which the image is captured from among the plurality of detectors.

According to an exemplary embodiment, there is provided an object detection method of the object detection apparatus, wherein information from a plurality of detectors respectively trained to detect an object from different viewpoints is stored in a storage, including: capturing an image from a viewpoint using an image capturing apparatus, wherein an object is captured within the image; transmitting the image in which the object is captured to an image receiver; and detecting the object in the image by applying information from a detector corresponding to the viewpoint from which the image is captured from among the plurality of detectors using a controller.

According to an exemplary embodiment, there is provided a non-transitory recording medium storing a program of operating an object detection method of an object detection apparatus in which information from a plurality of detectors respectively trained to detect an object from different viewpoints is stored in a storage, the object detection method including: transmitting an image captured by an image capturing apparatus to an image receiver, the image being captured from a viewpoint; and detecting the object in the image by applying information from a detector corresponding to the viewpoint from which the image is captured from among the plurality of detectors using a controller.

### BRIEF DESCRIPTION OF THE DRAWINGS

FIG. 1 is a schematic view explaining forms of an object in images according to image capturing viewpoints;

FIG. 2 is a block diagram explaining an object detection apparatus according to an exemplary embodiment;

FIG. 3 is a schematic view explaining determination on an image capturing direction according to an exemplary embodiment;

FIG. 4 is a view explaining an image scan according to an exemplary embodiment;

FIG. 5 is a flowchart explaining a sequential application of a detector according to an exemplary embodiment;

FIGS. 6A-6C are views explaining a window size set-up for an image scan according to an exemplary embodiment;

FIGS. 7A and 7B are views explaining an object detection apparatus according to various exemplary embodiments; and

FIG. 8 is a flowchart explaining an object detection method of an object detection apparatus according to an exemplary embodiment.

### DETAILED DESCRIPTION OF EXEMPLARY EMBODIMENTS

Certain exemplary embodiments are described in greater detail below with reference to the accompanying drawings.

In the following description, unless otherwise described, the same reference numerals are used for the same elements when they are depicted in different drawings. The matters defined in the description, such as detailed construction and elements, are provided to assist in a comprehensive understanding of exemplary embodiments. Thus, it is understood that exemplary embodiments can be carried out without those specifically defined matters. Also, functions or elements known in the related art are not described in detail since they would obscure exemplary embodiments with unnecessary detail.

The terms “first”, “second”, . . . may be used to describe diverse components, but the components should not be limited by the terms. The terms are only used to distinguish one component from the others.

The terms used in the present disclosure are only used to describe exemplary embodiments, but are not intended to limit the scope of the disclosure. Any singular expression should be understood as also including the plural meaning when appropriate in the context of the disclosure. In the present application, the terms “include,” “consists of,” or the like, designate the presence of features, numbers, steps, operations, components, elements, or a combination thereof that are written in the specification, but do not exclude the presence or possibility of addition of one or more other features, numbers, steps, operations, components, elements, or a combination thereof.

In exemplary embodiments described herein, a “module” or a “unit” performs at least one function or operation, and may be implemented in hardware, software, or a combination of hardware and software. In addition, a plurality of “modules” or a plurality of “units” may be integrated into at least one module except for a “module” or a “unit” which has to be implemented with specific hardware, and may be implemented with at least one processor.

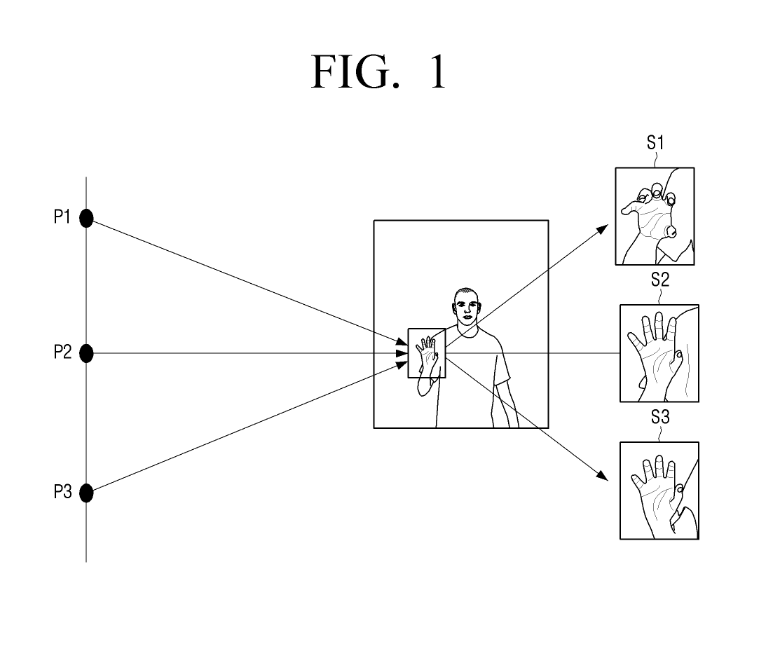

FIG. 1 is a view explaining forms of an object in images according to image capturing viewpoints.

Referring to FIG. 1, even though an identical object, a user's hand, is captured, different forms are captured according to a case in which an image capturing apparatus is at a position P1, a case in which the image capturing apparatus is at a position P2, and a case in which the image capturing apparatus is at a position P3. In other words, an upper part of the user's hand (S1) is captured from the viewpoint at position P1, a frontal form of the user's hand (S2) is captured from the viewpoint at position P2, and a lower part of the user's hand (S3) is captured from the viewpoint at position P3.

An object detection apparatus is trained to detect an object from various viewpoints and detects the object in consideration of a position of the image capturing apparatus in order to rapidly detect the object. For example, if the image capturing apparatus is at position P1, the object detection apparatus may detect the object by using a detector pre-trained at position P1; if the image capturing apparatus is at position P2, the object detection apparatus may detect the object by using a detector pre-trained at position P2; and if the image capturing apparatus is at position P3, the object detection apparatus may detect the object by using a detector pre-trained at position P3. Hereinafter, a configuration of the object detection apparatus is described in detail.

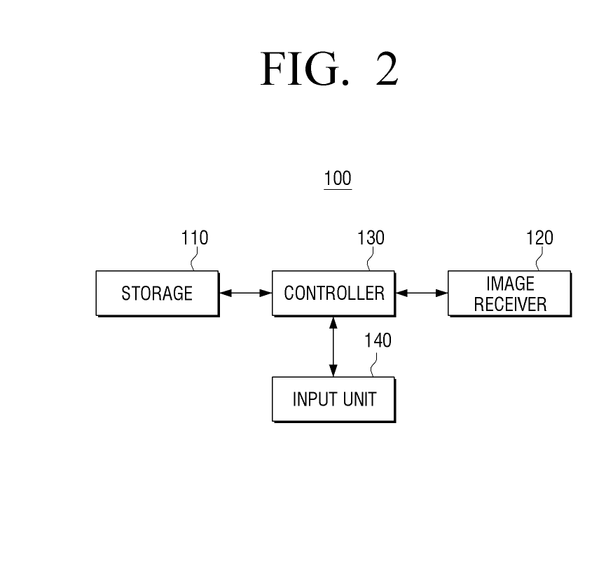

FIG. 2 is a block diagram explaining a configuration of the object detection apparatus according to an exemplary embodiment.

Referring to FIG. 2, the object detection apparatus 100 includes a storage 110, an image receiver 120, and a controller 130.

The storage 110 is configured to store various programs and data which are needed to operate the object detection apparatus 100. The storage 110 may include a hard disc drive (HDD) or flash memory.

Especially, in the storage 110, a plurality of detectors respectively trained to detect an object from different viewpoints is stored.

The detector includes a program trained to detect information of an object characteristic from a plurality of images where a specific object is captured at certain viewpoints, to generate a database by using the detected information, and to detect the object from the image input based on the database. By frequently and regularly being trained, the detector may update the database. Such a technology pertains to a machine learning field and since it is well-known technology to a person having ordinary skill in the technical field to which the present disclosure pertains, detailed description on the machine learning field is omitted.

The plurality of detectors stored in the storage 110 take charge of detecting an object captured at different viewpoints. For example, a first detector is trained to detect an object at position P1, a second detector is trained to detect the object at position P2, and a third detector is trained to detect the object at position P3. For example, if detectors 1-3 are stored in the storage 110, the first detector may be an appropriate detector when an image capturing apparatus is at position P1, as illustrated in FIG. 1; the second detector may be an appropriate detector when the image capturing apparatus is at position P2, as illustrated in FIG. 1; and the third detector may be an appropriate detector when the image capturing apparatus is at position P3, as illustrated in FIG. 1.

The image receiver 120 is configured to receive an image captured by the image capturing apparatus. Herein, an image includes both concepts of a still image and a video.

Herein, the image capturing apparatus is an element of obtaining an object image by performing an image capture. The image capturing apparatus may include at least one camera. Such image capturing apparatus may be included in the object detection apparatus 100 or connected to an exterior of the object detection apparatus 100, or may be installed at a position distant from the object detection apparatus 100. For the image capturing apparatus, image sensors such as complementary metal oxide semiconductor (CMOS), a charge coupled device (CCD), or the like, may be used. The image capturing apparatus may generate an image by capturing an object.

If the image capturing apparatus is installed in a position distant from the object detection apparatus 100, the image receiver 120 may function as a wired or wireless communication interface to receive an image captured by the image capturing apparatus. If the image capturing apparatus is included in the object detection apparatus 100 or connected to the exterior of the object detection apparatus 100, the image receiver 120 may function as an interface for receiving an image captured by the image capturing apparatus.

The image receiver 120, in order to communicate with an image capturing apparatus, may include various communication chips such as a Wi-Fi chip, a Bluetooth chip, a near-field communication (NFC) chip, a wireless communication chip, or the like. The Wi-Fi chip, the Bluetooth chip, the NFC chip, and the wireless communication chip respectively perform communications in a Wi-Fi system, a Bluetooth system, and a NFC system. Among these, the NFC chip may indicate a chip operates in a NFC system which uses the 13.56 MHz band among various RF-ID frequency bands such as 135 kHz, 13.56 MHz, 433 MHz, 860˜960 MHz, 2.45 GHz. In a case of using the Wi-Fi chip or the Bluetooth chip, various pieces of connection information such as a SSID and a session key may be first transceived and after communication is connected by these pieces of information, various pieces of information may be transceived. The wireless communication chip may indicate a chip which performs communication according to various communication standards such as IEEE, ZigBee, 3rd Generation (3G), 3rd Generation Partnership Project (3GPP), Long Term Evolution (LTE), or the like.

The controller 130 controls overall operation of the object detection apparatus 100. The controller 130 may determine an image capturing direction of an image received by the image receiver 120 and may detect an object from the image by applying, among the plurality of detectors stored in the storage 110, a detector corresponding to a determined image capturing direction to the image.

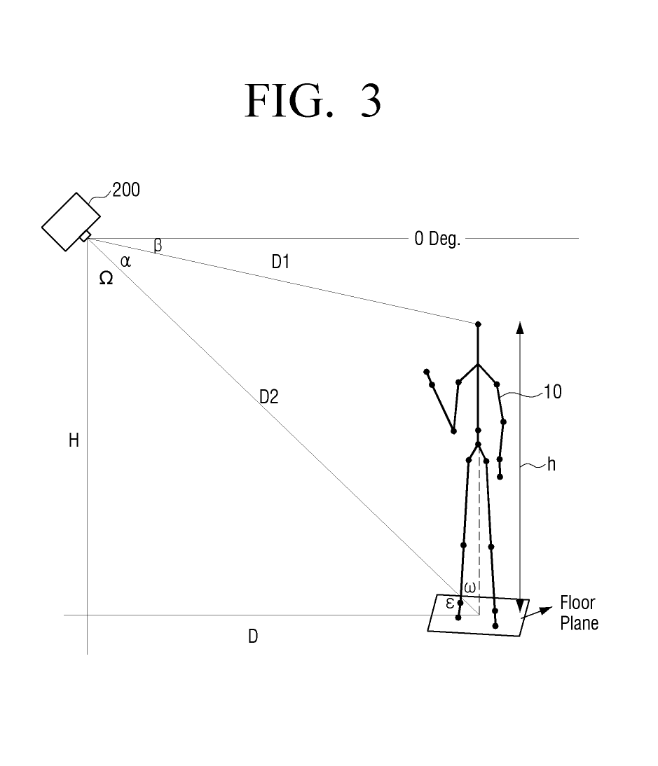

According to an exemplary embodiment, the controller 130 may analyze an image received by the image receiver 120 and may determine an image capturing direction of the image. An exemplary embodiment is described with reference to FIG. 3.

FIG. 3 is a view explaining how an image capturing direction is determined.

Referring to FIG. 3, an image capturing apparatus 200 is a device which may collect depth information of an object in an image. For example, the image capturing apparatus 200 may be a device including a depth sensor using infrared light and, may be embodied as a stereo camera which can collect depth information through stereo matching of two images or a depth camera.

The image capturing apparatus 200 may directly collect depth information and transmit the depth information to the object detection apparatus 100. In an exemplary embodiment, the controller 130 may extract depth information based on information and an image received from the image capturing apparatus 200.

For example, first, the controller 130 may extract a frame 10 of a user from a captured image and, based on depth information collected from the image capturing apparatus 200, may extract a distance D1 from a head of the user to the image capturing apparatus 200 and a distance D2 from a foot of the user to the image capturing apparatus 200. The controller may calculate a height h of the user based on distances D1 and D2. Therefrom, the controller 130 may obtain angles of a and w by a calculation using trigonometrical function and c may be obtained by a formula 90°−ω=ε. In addition, by using the trigonometrical function, the height H of the image capturing apparatus 200, a horizontal distance D between the image capturing apparatus 200 and the user and an angle Ω may be calculated and a gradient of image capture β of the image capturing apparatus 200 from degree of 0 (0 Deg.) may be obtained.

The controller 130 may determine an image capturing direction based on at least one of the height H of the image capturing apparatus 200 and the gradient of image capture β.

According to another exemplary embodiment, the object detection apparatus 100 may directly receive an information input such as the above from a user. For this, the object detection apparatus 100 may include an input unit 140 to receive information on a height H of the image capturing apparatus 200 or the gradient of image capture β from the user. For example, the input unit 140 may be embodied as a certain button or wired or wireless communication interface which may receive a user input from an exterior apparatus.

The controller 130 determines a capturing direction for an image based on at least one of the height H of the image capturing apparatus and the gradient of image capture β, and among a plurality of detectors, selects a detector corresponding to a determined capturing direction. And then, the controller 130 may detect an object from an image by applying the selected detector to the image.

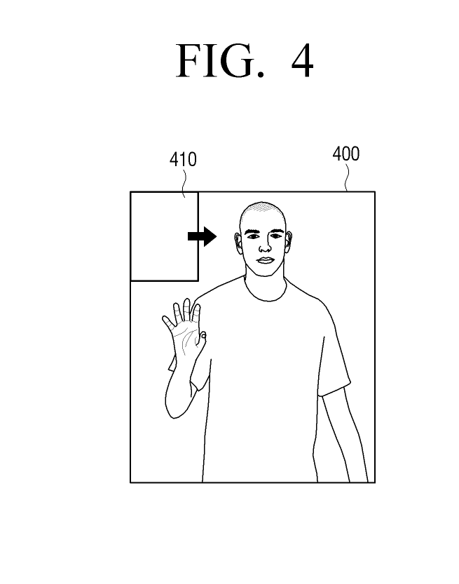

FIG. 4 is a view explaining the object detection method according to an exemplary embodiment.

Referring to FIG. 4, the controller 130 may scan all areas of an image 400 with a window 410 of a certain size and may detect an object by applying a selected detector in a window area. Specifically, the controller 130 may detect a characteristic of the object in the window area and analyze the characteristic by using the detector and, as a result of the analyzation, if it is determined that the object in the window area matches to an object subject to detection, the controller 130 may determine that the object is detected.

According the above-described exemplary embodiments, since an object can be detected by preferentially applying a detector corresponding to an image capturing direction, the present disclosure has an advantage of reducing object detection time when compared to conventional technology where a plurality of detectors are applied without an order. In other words, when an image capturing direction pertains to position P3 as illustrated in FIG. 1, by preferentially applying a detector trained about a lower part of a hand rather than applying a detector trained for an upper part or a frontal part of the hand, the object detection time is reduced.

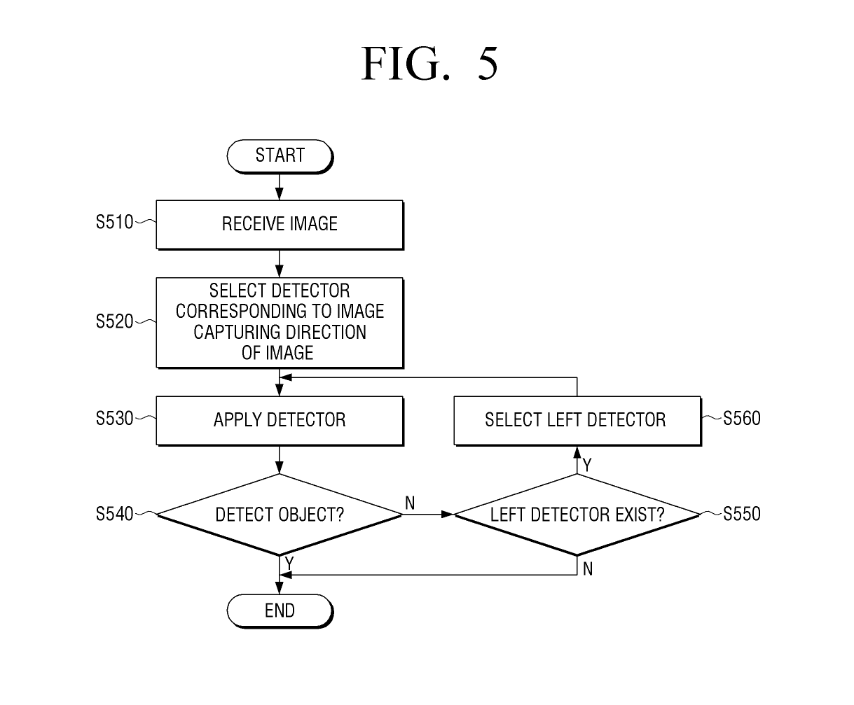

However, object detection by a detector corresponding to an image capturing direction is not always guaranteed. According to an exemplary embodiment, the controller 130 may preferentially apply a detector corresponding to an image capturing direction among a plurality of detectors to an image and if an object is not detected, the controller 130 may try to detect the object in the image by applying the other detectors in order. An exemplary embodiment is described with reference to FIG. 5.

Referring to FIG. 5, the controller 130 first receives an image from the image receiver 120 (S510). And then, the controller 130 determines an image capturing direction as described above and selects a detector corresponding to the determined image capturing direction (S520).

The controller 130 applies the detector corresponding to the image capturing direction to an image (S530). If object detection by the detector corresponding to the image capturing direction fails (S540, N), in response to an existence of a detector which was not applied to the current image among a plurality of detectors stored in the storage 110 (S550, Y), the controller 130 selects one of the detectors which were not applied to the current image (S560). After then, the controller 130 performs object detection by re-applying the selected detector to the image and repeats the above-described steps until an object is detected.

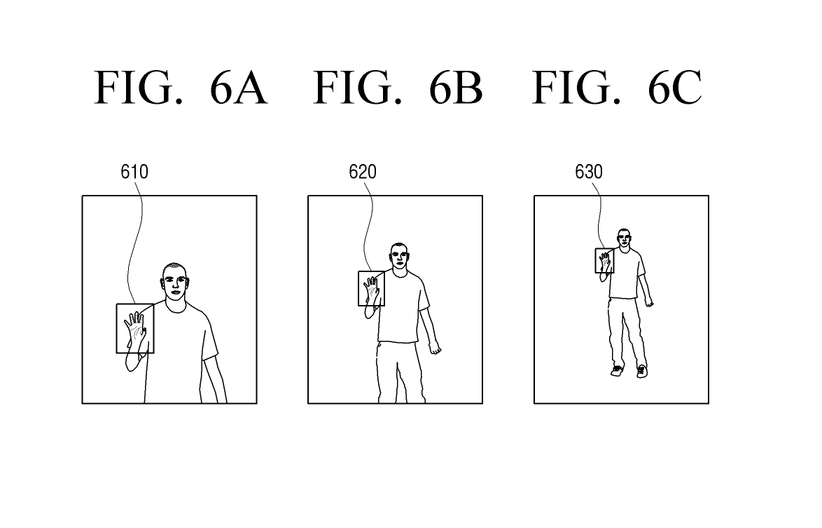

According to another exemplary embodiment, in consideration of not only an image capturing direction but also an object size in an image, namely, an image scale, object detection may be performed. An exemplary embodiment is described with reference to FIG. 6.

FIG. 6 is a view explaining the object detection method according to various image scales.

FIG. 6A is an image captured in a case where the image capturing apparatus is close to a user, FIG. 6B is an image captured in a case where the image capturing apparatus is at an intermediate distance from the user, and FIG. 6C is an image captured in a case where the image capturing apparatus is far from the user.

Based on information about a distance between the image capturing apparatus and the user, the controller 130 may determine a scale on which a detector performs detection. In other words, the controller 130 may determine with which size's window an image scan is performed.

For example, as illustrated in FIG. 6A, if the image capturing apparatus is close to the user, a first window 610 is appropriate for hand detection and a hand is not likely to be detected by a small size's window such as a second window 620 or a third window 630. Therefore, without a need to scan with an inappropriate size's window, in the case of FIG. 6A, it is advantageous to preferentially scan with the first window 610 in reducing object detection time.

For this, the controller 130 may estimate a size of the object in an image and may generate a window of which size corresponds to the estimated size.

The controller 130 scans the image in order with the generated window and detects an object by applying a detector in a window area. In other words, the detector is set to detect an object in image scale that matches the estimated size of the object.

However, even though a window of which size corresponds to an estimated size is used, object detection is not always guaranteed. Therefore, when the object detection with the window of which size corresponds to the estimated size fails, the controller 130 may re-scan the image with windows of different sizes and may detect an object by applying a detector in a window area.

According to an exemplary embodiment, in order to estimate a size of an object, the controller 130 may analyze an image and calculate a horizontal distance between a user and the image capturing apparatus.

For example, as illustrated in FIG. 3, the controller 130 may calculate a horizontal distance D between the image capturing apparatus and a user.

In addition, the controller 130 may directly receive information about the horizontal distance between the image capturing apparatus and the user from the user through an input unit 140.

If an object to detect is a human hand, when a horizontal distance D between the image capturing apparatus and the user is known, based on information about a general ratio of a human body, a size of the hand may be estimated in an image.

According to the above-described exemplary embodiment, since an image may be scanned with an appropriate size's window, object detection time may be reduced as compared to when the image is scanned with windows of all sizes.

After an object is detected from an image, if a follow-up image is received from the image receiver 120, the controller 130 may track the object by detecting the object in the follow-up image that matches the detected object.

In other words, with regard to the follow-up image, even though an object is not detected through the above-described series of steps, with information about a pre-detected object, an object may be tracked. Therefore, the controller 130 may rapidly recognize a moving path of the object and may perform a command corresponding to the recognized movement.

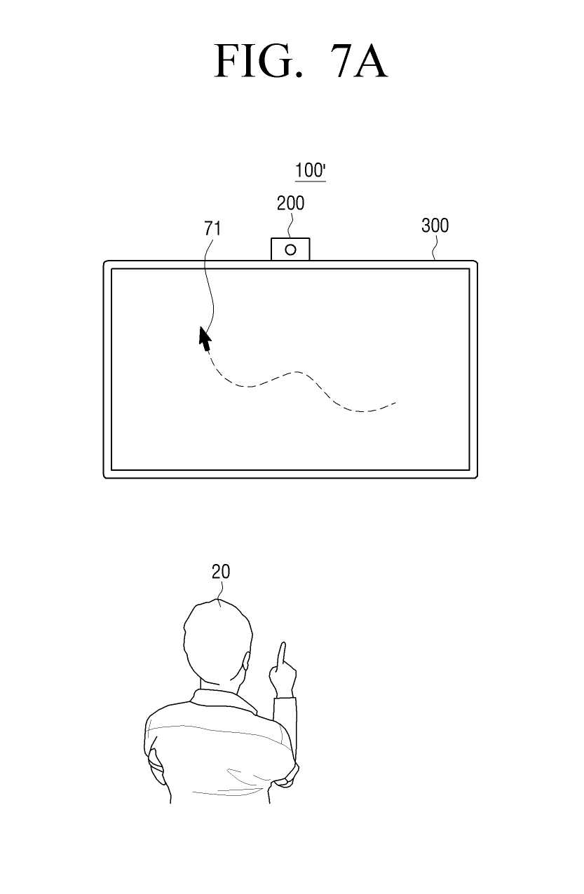

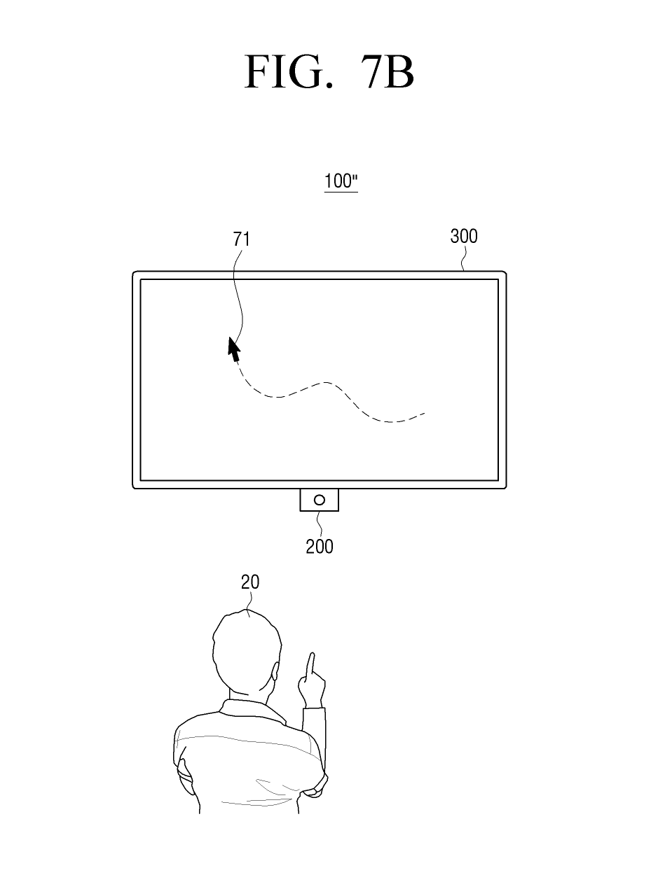

According an exemplary embodiment, the object detection apparatus 100 may be embodied as a display apparatus which may be controlled by a motion of a user. An exemplary embodiment is described with reference to FIGS. 7A and 7B.

FIGS. 7A and 7B are views explaining the object detection apparatus according to an exemplary embodiment.

Referring to FIGS. 7A and 7B, object detection apparatuses 100′ and 100″ may include the image capturing apparatus 200 and a display 300.

Object detection apparatuses 100′ and 100″ may perform a movement corresponding to a movement of a detected object. For example, as illustrated in FIGS. 7A and 7B, according to a finger movement of a detected user 20, a movement where a cursor 71 moves on the display 300 may be performed.

As illustrated in FIG. 7A, if the image capturing apparatus 200 is located on an upper part of the display 300, among a plurality of detectors stored in the object detection apparatus 100′, a detector trained for an upper part of a user's hand is preferentially applied to an image and object detection is performed.

On the contrary, as illustrated in FIG. 7B, if the image capturing apparatus 200 is located at a lower part of the display 300, among a plurality of detectors stored in the object detection apparatus 100″, a detector trained for a lower part of a user's hand is preferentially applied to an image and object detection is performed.

As described the above, if object detection is performed by preferentially applying a detector trained to detect the object at a current viewpoint of the image capturing apparatus, the object may be detected more rapidly.

The above described various exemplary embodiments may be embodied in a computer readable recording medium or a recording medium which may be read by a device similar to a computer by using software, hardware, or a combination of software and hardware. By hardware embodiment, exemplary embodiments described in the present disclosure may be embodied by using at least one of various electronic units including application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like. In some cases, exemplary embodiments described in the present disclosure may be embodied as the controller 130, itself. By software embodiment, exemplary embodiments such as process and functions described in the present specification may be embodied as separate software modules. The software modules may respectively perform at least one or more than one function and operation described in the present specification.

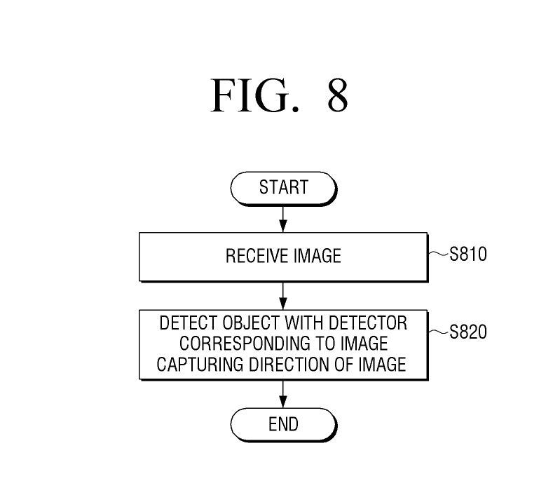

The above-described exemplary embodiments provide an effect of detecting an object more rapidly and more exactly than when detecting an object by applying detectors in a random order to an image. Hereinafter, the object detection method of the object detection apparatus is described with reference to FIG. 8.

FIG. 8 is a flowchart explaining the object detection method of the object detection apparatus according to an exemplary embodiment. The object detection apparatus is a device where a plurality of detectors respectively trained to may detect an object at viewpoints different from each other are stored.

Referring to FIG. 8, the object detection apparatus 100 receives an image where an object is captured by the image capturing apparatus (S810). Herein, the image capturing apparatus may be set to continuously capture a subject for photography and may be set to capture the subject for photography according to a user command which is input to the object detection apparatus 100.

The object detection apparatus 100, among a plurality of pre-stored detectors, detects an object in an image by applying a detector corresponding to an image capturing direction (S820).

In this case, the object detection apparatus 100 may directly receive an information input about a height of the image capturing apparatus or a gradient of image capture from a user and determine an image capturing direction based on the information input.

Or, the object detection apparatus 100 may extract at least one piece of information of a height of the image capturing apparatus and the gradient of image capture by analyzing a received image and may determine a capturing direction of the received image based on the extracted information.

When object detection with a selected detector fails, the object detection apparatus 100 may apply the other detectors in order. In other words, by applying the plurality of detectors to an image in order, an object in the image may be detected. In this case, if the object is not detected when a detector corresponding to an image capturing direction was preferentially applied to the image, the object may be detected in the image by the other detectors being applied in order.

The object detection apparatus 100 may estimate a size of an object to detect by analyzing an image. Also, the object detection apparatus 100 may control a detector to perform object detection in scale corresponding to a size of the estimated object.

Specifically, the object detection apparatus 100 may estimate a size of the object by analyzing the image, generate a window of which size corresponds to the estimated size, and detect the object by scanning the image in order with the window and by applying the detector in a window area.

In this case, if object detection with the window of which size corresponds to the estimated size fails, the object detection apparatus 100 may generate a window of a size different from the size of the window and perform the object detection again by re-scanning the image.

Per window, a plurality of detectors may be applied in order. Therefore, if an object is not detected even though all detectors performed detection in a certain size's window, in a different size's window, the detection is performed again with all detectors. In this case, per window performs detection by preferentially applying a detector corresponding to an image capturing direction.

If an object to detect is part of a user's body, the object detection apparatus 100 may analyze an image, extract information about a distance between a user's foot and the image capturing apparatus and a distance between a user's head and the image capturing apparatus and estimate a size of the object by calculating a horizontal distance between the extracted information and the image capturing apparatus.

If a follow-up image is received from the image capturing apparatus, with regard to the follow-up image, not by performing object detection while applying a detector but based on information about a form of a pre-detected object, an object matching the pre-detected object may be detected. Accordingly, a movement of the object in a series of images may be tracked more rapidly.

In addition to the steps described with reference to FIG. 8, various exemplary embodiments of the object detection method can be derived by performances which are carried out in various exemplary embodiments described with reference to FIGS. 1-7B. Therefore, descriptions of such exemplary embodiments which are in a range repetitive to the above-described exemplary embodiments are omitted.

The object detection method according to the above-described various exemplary embodiments may be embodied as a program including an implementable algorithm which may be carried out in a computer and the program may be provided by being stored in a non-transitory computer readable medium. Such a non-transitory computer readable medium may be used by being mounted on various devices.

The non-transitory computer readable medium indicates a medium which can semi-permanently store data and which is readable by a device rather than a medium that stores data for a short time such as a register and cache memory. Specifically, programs of performing the above-described various methods can be stored in a non-transitory computer readable medium such as a CD, a DVD, a hard disk, a Blu-ray disk, universal serial bus (USB), a memory card, ROM, or the like, and can be provided.

Accordingly, an object may be more rapidly detected in an image by the above-described program being installed in an existing device and performing object detection.

While exemplary embodiments of this disclosure have been illustrated and described, it will be understood by those skilled in the art that various changes in form and details can be made therein without departing from the spirit and scope of the present disclosure as defined by the appended claims. Therefore, the scope of the disclosure is defined not by the detailed description of exemplary embodiments, but by the appended claims, and all differences within the scope will be construed as being included in the present disclosure.

What is claimed is:

1. An object detection apparatus, comprising:
a storage configured to store information from a plurality of detectors respectively trained to detect an object from different viewpoints;
an image receiver configured to receive an image in which the object is captured by an image capturing apparatus; and
a controller configured to detect the object in the image by applying information from a detector corresponding to the viewpoint from which the image is captured from among the plurality of detectors.

2. The apparatus as claimed in claim 1, wherein
the controller preferentially applies information from the detector corresponding to the viewpoint from which the image is captured from among the plurality of detectors, and in response to the object not being detected by the detector, applies information from the other detectors in order and detects the object from the image.

3. The apparatus as claimed in claim 1, wherein
the controller estimates a size of the object by analyzing the image, generates a first window, the size of the first window corresponding to the estimated size, and detects the object by scanning the image with the first window and by applying information from the detector in a first window area corresponding to the first window.

4. The apparatus as claimed in claim 3, wherein
the controller, in response to a failure of object detection with the first window, detects an object by rescanning the image with a second window whose size is different from the size of the first window and by applying information from the detector in a second window area corresponding to the second window.

5. The apparatus as claimed in claim 3, wherein
the controller, in response to the object being part of a user's body, extracts information about a distance between a foot of the user and the image capturing apparatus and a distance between a head of the user and the image capturing apparatus by analyzing the image, and estimates a size of the object by calculating a horizontal distance between the user and the image capturing apparatus from the extracted information.

6. The apparatus as claimed in claim 1, further comprising:
an input unit configured to receive an input of information about a height of the image capturing apparatus or a gradient of image capture,
wherein the controller determines an image capturing direction of the image based on at least one of the input height of the image capturing apparatus and the input gradient of image capture.

7. The apparatus as claimed in claim 1, wherein
the controller extracts information about at least one of the height of the image capturing apparatus and the gradient of image capture by analyzing the image, and determines an image capturing direction of the image based on the extracted information.

8. The apparatus as claimed in claim 1, wherein
the controller, in response to a follow-up image being received through the image receiver, detects an object which matches the detected object in the follow-up image and tracks a movement of the object.

9. An object detection method of an object detection apparatus, wherein information from a plurality of detectors respectively trained to detect an object from different viewpoints is stored in a storage, comprising:
receiving an image in which the object is captured by an image capturing apparatus; and
detecting the object in the image by applying information from a detector corresponding to the viewpoint from which the image is captured from among the plurality of detectors using a controller.

10. The method as claimed in claim 9, wherein
detecting the object in the image comprises preferentially applying information from the detector corresponding to the viewpoint from which the image is captured from among the plurality of detectors, and in response to the object not being detected by the detector, detecting an object from the image by applying information from the other detectors in order.

11. The method as claimed in claim 9, wherein
detecting the object in the image comprises estimating a size of the object by analyzing the image, generating a first window, the size of which corresponds to the estimated size, and detecting the object by scanning the image with the first window and by applying information from the detector in a first window area corresponding to the first window.

12. The method as claimed in claim 11, wherein
detecting the object in the image comprises, in response to a failure of object detection with the first window, detecting an object by rescanning the image with a second window whose size is different from the size of the first window and by applying information from the detector in a second window area corresponding to the second window.

13. The method as claimed in claim 11, wherein
detecting the object in the image, in response to the object being part of a user's body, comprises extracting information about a distance between a foot of the user and the image capturing apparatus and a distance between a head of the user and the image capturing apparatus by analyzing the image, and estimating a size of the object by calculating a horizontal distance between the user and the image capturing apparatus from the extracted information.

14. The method as claimed in claim 9, further comprising:
receiving an input of information about a height of the image capturing apparatus or a gradient of image capture using an input unit,
wherein detecting the object in the image determines an image capturing direction of the image based on at least one of the input height of the image capturing apparatus and the input gradient of image capture.

15. The method as claimed in claim 9, wherein
detecting the object in the image comprises extracting information about at least one of the height of the image capturing apparatus and the gradient of image capture by analyzing the image and determining an image capturing direction of the image based on the extracted information.

16. The method as claimed in claim 9, further comprising:
in response to a follow-up image being received from the image capturing apparatus, detecting an object which matches the detected object in the follow-up image and tracking a movement of the object.

17. A non-transitory recording medium storing a program of operating an object detection method of an object detection apparatus in which information from a plurality of detectors respectively trained to detect an object from different viewpoints is stored in a storage, the object detection method comprising:
receiving an image captured by an image capturing apparatus, the image being captured from a viewpoint; and
detecting the object in the image by applying information from a detector corresponding to the viewpoint from which the image is captured from among the plurality of detectors using a controller.
